(19) United States
(12) Patent Application Publication
(10) Pub. No.: US 2013/0010364 A1
(43) Pub. Date: Jan. 10, 2013

(54) ANTI-REFLECTIVE FILMS WITH CROSS-LINKED SILICONE SURFACES, METHODS OF MAKING AND LIGHT ABSORBING DEVICES USING SAME

(76) Inventors: Timothy J. Hebrink, Scandia, MN (US); Todd G. Pett, Minneapolis, MN (US)

(21) Appl. No.: 13/518,724

(22) PCT Filed: Dec. 16, 2010
(86) PCT No.: PCT/US10/60698

§ 371 Date: Jun. 22, 2012

Related U.S. Application Data
(60) Provisional application No. 61/291,479, filed on Dec. 31, 2009.

(51) Int. Cl. G02B 1/11; B23P 11/00; B05D 3/00

(52) U.S. Cl. 359/601; 427/444; 29/428

(57) ABSTRACT

A transparent anti-reflective structured film comprising a structured film substrate having a structured face, with anti-reflective structures defining a structured surface. The structured film substrate comprises a silicone elastomeric material. The structured face is anti-reflective to light. The structured surface has a silicone elastomer cross-link density that is higher than a remainder of the transparent anti-reflective structured film (e.g., a remainder of the structured film substrate). A light energy absorbing device comprising the transparent anti-reflective structured film disposed so as to be between a source of light energy and a light energy receiving face of a light absorber, when light energy is being absorbed by the light absorber.

### FIELD OF THE INVENTION

The present invention pertains to transparent anti-reflective structured films, in particular, to transparent anti-reflective structured films comprising a cross-linked silicone elastomeric material, and more particularly, to such films having an anti-reflective structured surface with a silicone elastomer cross-link density that is higher than a remainder of the anti-reflective structured film.

### BACKGROUND

With the rising costs of conventional power generation based on burning fossil fuels (e.g., oil and coal based power plants), and the desire to reduce associated greenhouse gases, investment into non-conventional sources of power have increased. For example, the US Department of Energy has invested heavily into the research and development of solar power generation (e.g., solar energy based hot water and electricity generation). One such non-conventional source of power generation is the use of photovoltaic cells to convert solar light energy into electricity. Solar light energy has also been used to directly or indirectly heat water for residential and commercial use. Along with this increased level of interest, there is a need for improving the efficiency at which such non-conventional solar energy technologies can absorb light energy and thereby increase the amount of solar energy available for use.

### SUMMARY OF THE INVENTION

The present invention provides a way to improve the efficiency (i.e., increase the energy generating potential) of solar and other light energy absorbing technologies by enabling more useful light energy into the corresponding light absorbing element (e.g., photovoltaic cell).

In one aspect of the present invention, a transparent anti-reflective structured film is provided that comprises a structured film substrate comprising a structured face having anti-reflective structures. The structured face is anti-reflective to light. At least the anti-reflective structures comprise a cross-linked silicone elastomeric material. Each anti-reflective structure has a structured surface. The structured surface has a silicone elastomer cross-link density that is higher than a remainder of the anti-reflective structured film.

Silicone elastomers are known for their stability under long-term ultra-violet light exposure, and they can be optically clear and tough. Unfortunately, silicone elastomers also have relatively tacky surfaces that tend to attract, pick-up and hold dirt and dust particles. Until now, this characteristic of picking-up and holding dirt and dust has made silicone elastomers an undesirable candidate for forming the exposed surface of a light energy absorbing or conversion device such as, e.g., an optically transparent prismatic cover for a photovoltaic cell. The present invention is predicated, at least in part, on the discovery that this tackiness of silicone elastomeric surfaces can be significantly reduced, and their resistance to dirt and dust particle pick-up significantly increased, by increasing the cross-link density of at least the surface of the silicone elastomer. Such an increase in cross-link density can also increase the abrasion resistance of the silicone elastomer surface. Therefore, in this aspect of the present invention, the structured surface of the film, which is on the top exposed side of the film, has a silicone elastomer cross-link density that is higher than a remainder of the structured film substrate or at least of the transparent anti-reflective structured film.

It can be desirable for only an outer layer of each anti-reflective structure to exhibit the higher silicone elastomer cross-link density. It may also be desirable for all or most of the silicone elastomeric material of each anti-reflective structure to exhibit the higher silicone elastomer cross-link density. The anti-reflective structures can project out from a base portion or backing of the structured film substrate. When all of each anti-reflective structure exhibits the higher silicone elastomer cross-link density, the film base portion or backing of the structured film substrate can be the only portion of the film that does not exhibit the higher silicone elastomer cross-link density. The depth of the higher silicone elastomer cross-link density, from the structured surface into the structured film substrate, depends on the settings (e.g., intensity and/or duration) of the treatment (e.g., voltage and/or dosage of a conventional e-beam radiation curing techniques) used to cross-link the silicone elastomeric material.

In another aspect of the present invention, a method is provided for making a transparent anti-reflective structured film according to the present invention. The method first comprises providing a structured film substrate comprising a structured face having anti-reflective structures defining a structured surface, with the structured face being anti-reflective to light, and the structured film substrate comprising a cross-linked silicone elastomeric material. Next, the method comprises treating the structured surface such that the structured surface has a higher silicone elastomer cross-link density than the remainder of the structured film substrate.

The step of providing a structured film substrate can comprise providing a silicone elastomer precursor material that is curable so as to form the cross-linked silicone elastomeric material, forming the silicone elastomer precursor material into the shape of the structured film substrate, and curing the silicone elastomer precursor material so as to form the structured film substrate. Depending on the method and settings used to further cross-link the already cross-linked silicone elastomeric material, and thereby produce the structured surface having the higher silicone elastomer cross-link density, there may be a remaining portion of the anti-reflective structures that does not exhibit the higher silicone elastomer cross-link density.

In an additional aspect of the present invention, a light energy absorbing device (e.g., solar hot water system, photovoltaic electric generating system, etc.) is provided that comprises a light absorber (e.g., solar hot water circulating tubes or other conduits, photovoltaic cell, etc.) and a transparent anti-reflective structured film. The light absorber has a light energy receiving face, and the transparent anti-reflective structured film is disposed so as to be between a source of light energy (e.g., the sun) and the light energy receiving face, at least while light energy from the source is being absorbed by the light absorber. Light energy absorbing devices (e.g., solar energy conversion devices) are used in a wide array of applications, both earth-bound applications and space-based applications. In some embodiments, the solar energy conversion device may be attached to a vehicle, such as an automobile, a plane, a train or a boat. Many of these environments are very hostile to organic polymeric materials.

In a further aspect of the present invention, a method is provided for making a light energy absorbing device. This method comprises providing a transparent anti-reflective structured film according to the present invention, providing a light absorber having a light receiving face, and securing the anti-reflective structured film to the light absorber so that light can pass through the anti-reflective structured film to the light receiving face of the light absorber.

As used herein and unless otherwise indicated, the term “film” is synonymous with a sheet, a web and like structures.

As used herein, the term “transparent” refers to the ability of a structure, e.g., the inventive film, to allow a desired bandwidth of light transmission therethrough. A structure can still be transparent, as that term is used herein, without also being considered clear. That is, a structure can be considered hazy and still be transparent as the term is used herein. It is desirable for a transparent structure according to the present invention to allow at least 85%, 91%, 92%, 93%, 94%, 95%, 96%, 97% or 98% light transmission therethrough. The present invention can be useful with a wide band of light wavelengths. For example, it can be desirable for the present invention to be transparent to the transmission of light within the wavelength band of from about 400 nm to about 2500 nm. This band generally corresponds to the band of visible light including near infrared (IR) light.

As used herein, the term “anti-reflective structures” refers to surface structures that change the angle of incidence of light such that the light enters the polymeric material beyond the critical angle and is internally transmitted.

As used herein, the term “silicone elastomer cross-link density” refers to the average cross-link density of that portion of the silicone elastomeric material forming a particular film element of interest (e.g., the structured surface, the anti-reflective structure(s), the structured film substrate, etc.). The average cross-link density is typically measured in grams per mole per cross-link point (i.e., molecular weight of the chains between points of cross-links).

The terms “comprises” and variations thereof do not have a limiting meaning where these terms appear in the description and claims.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably, unless the content clearly dictates otherwise.

The term “and/or” means one or all of the listed elements or a combination of any two or more of the listed elements (e.g., preventing and/or treating an affliction means preventing, treating, or both treating and preventing further afflictions).

As used herein, the term “or” is generally employed in its sense including “and/or” unless the content clearly dictates otherwise.

Also herein, the recitations of numerical ranges by endpoints include all numbers subsumed within that range (e.g., the range 1 to 5 includes 1, 1.5, 2, 2.75, 3, 3.80, 4, 4.6, 5, 5.3, etc.) and any range within that range.

The terms “polymer” or “polymeric” and “elastomer” and “elastomeric” will be understood to include polymers, copolymers (e.g., polymers formed using two or more different monomers), oligomers and combinations thereof, as well as polymers, oligomers, or copolymers that can be formed in a miscible blend.

The use of anti-reflective structured films, as disclosed herein, have demonstrated reductions in the amount of light that is reflected and does not reach the light absorbing element(s) of the light energy absorbing device. For example, such anti-reflective structured films have enabled conventional photovoltaic solar modules to experience average power output increases in the range of from about 3% to about 7%. The present invention can help maintain the transparency to light of such anti-reflective structured films, during the life of the light energy absorbing device, by improving the resistance to dirt and dust particle pick-up (i.e., dirt resistance) and/or abrasion resistance of the exposed surface of the anti-reflective structured film. In this way, the present invention can help to reduce the amount of incident light reflecting off of the light exposed surface(s) of such light energy absorbing devices. In particular, by more highly cross-linking the silicone elastomeric material at the structured surface of the structured face, the structured face can exhibit improved mechanical durability (e.g., resistance to falling sand) compared to the same silicone elastomeric material without the higher cross-linking, as well as compared to the same structured face made with other polymeric materials (e.g., polyurethanes). Dirt and dust particles that do accumulate on such a structured face can also be relatively easier to clean.

Light energy absorbing devices, and especially the structured face of the anti-reflective structured film, may be exposed to a variety of detrimental conditions from outside environments. For example, the structured face can be exposed to environmental elements such as rain, wind, hail, snow, ice, blowing sand, and the like which can damage the structured surface of the structured face. In addition, long term exposure to other environmental conditions such as heat and UV radiation exposure from the sun can also cause degradation of the structured face. For example, many polymeric organic materials are susceptible to breaking down upon repeated exposure to UV radiation. Weatherability for light energy absorbing devices such as, for example, a solar energy conversion device is generally measured in years, because it is desirable that the materials be able to function for years without deterioration or loss of performance. It is desirable for the materials to be able to withstand up to 20 years of outdoor exposure without significant loss of optical transmission or mechanical integrity. Typical polymeric organic materials are not able to withstand outdoor exposure without loss of optical transmission or mechanical integrity for extended periods of time, such as 20 years. In at least some embodiments, the structured face of the present invention is expected to exhibit dirt resistance and/or mechanical durability in the range of from at least about 5 years to at least about 20 years, and possibly longer (e.g., at least about 25 years). In addition, because it is made of a silicone material, the structured face can exhibit long term UV stability of at least about 15 years, about 20 years or even about 25 years.

These and other advantages of the invention are further shown and described in the drawings and detailed description of this invention, where like reference numerals are used to represent similar parts. It is to be understood, however, that the drawings and description are for illustration purposes only and should not be read in a manner that would unduly limit the scope of this invention.

### BRIEF DESCRIPTION OF THE DRAWINGS

In the accompanying drawings:

FIG. 1 is a side edge view of a transparent anti-reflective structured film embodiment of the present invention;

FIG. 2 is a side edge view of an alternative transparent anti-reflective structured film embodiment of the present invention;

FIG. 3 is a side edge view of another transparent anti-reflective structured film embodiment of the present invention;

FIG. 4 is a side view of a light energy absorbing device embodiment having a transparent anti-reflective structured film disposed so as to increase the amount of light being absorbed by a light absorber; and

FIG. 5 is a side view of another light energy absorbing device embodiment showing the paths of reflection incident light can travel when so as to increase the amount of light absorbed by the light absorber.

### DETAILED DESCRIPTION OF CERTAIN EMBODIMENTS

The description that follows more particularly exemplifies illustrative embodiments. In describing the following embodiments of the present invention, specific terminology is used for the sake of clarity. The invention, however, is not intended to be limited to the specific terms so selected, and each term so selected includes all technical equivalents that operate similarly. In addition, the same reference numbers are used to identify the same or similar elements of the different illustrated embodiments.

Unless indicated to the contrary, the numerical parameters set forth in the foregoing specification and attached claims are approximations that can vary depending upon the desired properties sought to be obtained by those skilled in the art utilizing the teachings disclosed herein.

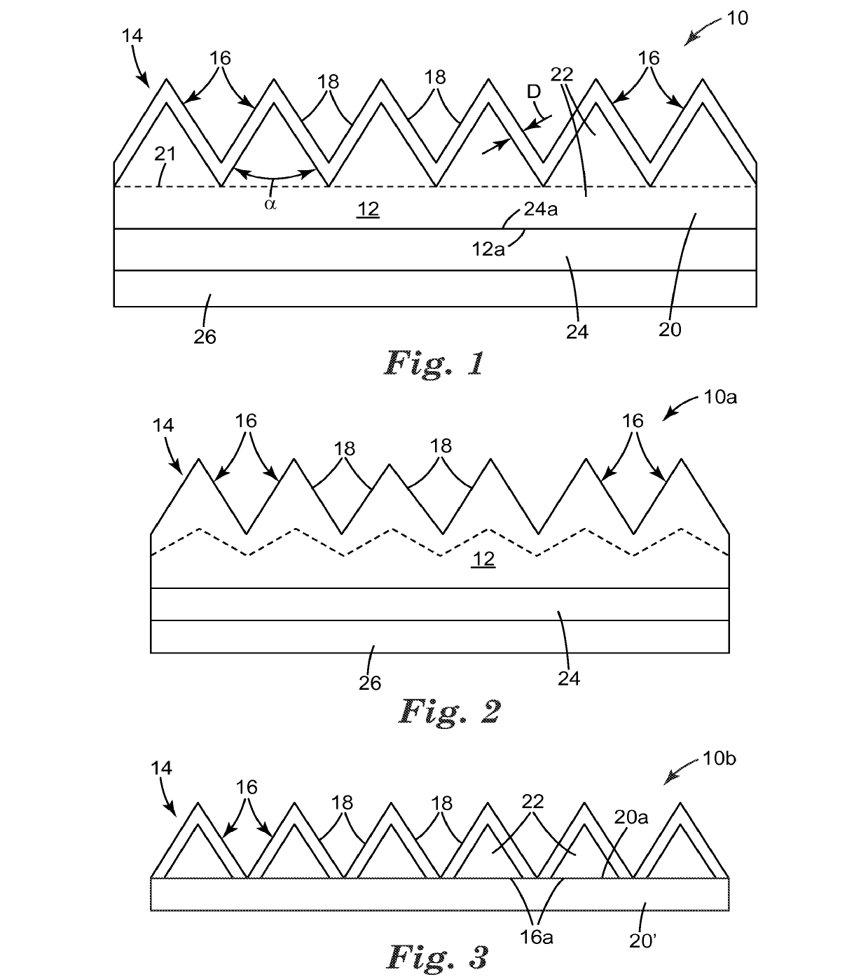

Referring to FIG. 1, an exemplary transparent anti-reflective structured film 10 comprises a structured film substrate 12 that has a major structured face 14 with anti-reflective structures, for example, in the form of prismatic riblets 16 that are anti-reflective to light (see FIG. 5). Each anti-reflective structure 16 has a tip angle α and a structured surface 18 that is exposed. The film 10 further comprises a base portion 20 from which the anti-reflective structures 16 extend. The base portion 20 can be an integrally formed part of the structures 16 as illustrated, or a separate layer as indicated by the dashed line 21. The structured film substrate 12 comprises a cross-linked silicone elastomeric material. The silicone elastomeric material may be, for example, a two-part silicone rubber (e.g., Momentive RTV615 Silicone), polydimethyl siloxane (e.g., PDMS-S51), etc., or a combination thereof. The structured face 14 is exposed to an additional cross-linking treatment (e.g., e-beam radiation, ultra-violet light, and/or heat energy) such that each structured surface 18 has a silicone elastomer cross-link density that is higher than a core or otherwise remainder 22 of the structured film substrate 12. The depth D of the higher cross-link density depends on the exposure intensity and/or duration of the additional cross-linking treatment. The higher cross-link density of the structured surface 18 results in an increased resistance to dirt and dust particle pick-up (indicated by the dirt pick-up test results), as well as an increase in the abrasion resistance (indicated by the falling sand test results), of the silicone elastomer surface 18.

It can be desirable for the film 10, or any other transparent anti-reflective structured film according to the invention, to be used in combination with an optional transparent support backing 24. With such an embodiment, the support backing 24 has a major face 24a, and the structured film substrate 12 further comprises a major backing face 12a bonded to the major face 24a of the support backing 24 so as to form a transparent reinforced anti-reflective structured film. The support backing 24 can comprise a polymeric material or a glass or other transparent ceramic material. Exemplary polymeric materials may include at least one or a combination of a polymethyl(meth)acrylate (PMMA) film, polyvinylidene fluoride (PVDF) film, polyethylene terephalate (PET) film, primed PET film, polycarbonate film, cross-linked polyurethane film, acrylate film, ethylene tetrafluoroethylene (ETFE), fluorinated ethylene-propylene (FEP) film, or blends thereof. Ultra-violet light absorbers (such as Tinuvin 1577 from Ciba Geigy) can be incorporated into PMMA and blends of PVDF and PMMA for improved outdoor durability. The other transparent ceramic material may be, e.g., quartz crystal, etc. Transparent nonwoven or woven fiber materials, or chopped transparent fibers, may also be used to form the support backing 24. Such fiber materials can either be disposed in the silicone elastomeric material forming the structured film 10, disposed on the structured film 10, or both.

The transparent support backing 24 can also be chosen so as to dissipate static electricity. For example, the support backing can comprise one or more polymeric materials that enable the support backing 24 to dissipate static electricity. In order to dissipate static electricity, the transparent support backing 24 may also comprise an inherently static dissipative polymer such as those available as STATRITE X5091 polyurethane or STATRITE M809 polymethyl metacrylate from Lubrizol Corp. Alternatively, static dissipative salts such as FC4400 available from 3M Company can be blended into the polymer used to make the transparent support backing 24 (e.g., PVDF). In addition, or alternatively, the structured film substrate 12 can comprise such static dissipative salts.

Instead of, or in addition to the support backing 24, it can also be desirable for the film 10, or any other transparent anti-reflective structured film according to the invention, to be used in combination with an optional moisture barrier layer 26. In such an embodiment, the moisture barrier layer 26 can be formed, for example, by laminating, coating or otherwise bonding the moisture resistant barrier layer 26 indirectly through one or more intermediate layers (e.g., the support backing layer 24) or directly onto the major backing face 12a of the structured film substrate 12. Alternatively, the moisture barrier layer 26 can be formed by formulating the composition of the film 10 so as to exhibit moisture barrier properties (e.g., so as to inhibit moisture absorption, permeation, etc.).

The moisture barrier may be, for example, a barrier assembly or one or more of the barrier layers disclosed in International Patent Application No. PCT/US2009/062944, U.S. Pat. Nos. 7,486,019 and 7,215,473, and Published U.S. Patent Application No. US 2006/0062937 A1, which are incorporated herein by reference in their entirety. A moisture barrier may be useful, because silicone has a high moisture vapor transmission rate and photovoltaic cells are typically moisture sensitive. Therefore, by being backed with a moisture barrier layer, a transparent anti-reflective structured film of the invention can be used directly on moisture sensitive photovoltaic cells (e.g., Copper/Indium/Gallium/Selenium or CIGS photovoltaic cells).

Referring to FIG. 2, in another embodiment 10a of the transparent anti-reflective structured film of the invention, the major structured face 14 is exposed to additional cross-linking such that all of the silicone elastomeric material of each of the anti-reflective structures 16 has a silicone elastomer cross-link density about as high as that of the structured surface 18, with the remainder 22 of the film 10a having a lower silicone elastomer cross-link density than that of each of the anti-reflective structures 16. Dashed line 23 separates the higher cross-link density portion of film 10a from the lower cross-link density portion.

Referring to FIG. 3, in an additional embodiment 10b of the transparent anti-reflective structured film of the invention, each of the anti-reflective structures 16 extend out from a separate base portion 20′. The separate base portion 20′ can be one or more layers of a cross-linked silicone elastomeric material, or the separate base 20′ can be one or more layers of a different material (e.g., less expensive material like PMMA, PVDF and PET). The separate base 20′ is adhered or otherwise bonded to the anti-reflective structures 16 by any suitable means, depending on the compatibility between the silicone elastomeric material and the different material. For example, the base portion 20′ can have a major face 20a that is optionally coated with a primer or otherwise treated (e.g., a corona treatment) or prepared for receiving and bonding with a major backing face 16a of each of the silicone elastomeric anti-reflective structures 16. The anti-reflective structures 16 can be formed, for example, by using a tooling film (not shown) having a micro-replicated pattern formed in at least one of its major surfaces that matches the desired pattern of anti-reflective structures 16.

A layer of the desired silicone elastomer precursor material can be extruded, coated or otherwise applied onto the surface of the base portion face 20a. The micro-replicated major surface of the tooling film can then be brought into contact with the layer of silicone elastomer precursor material so as to form the exposed surface of the applied silicone elastomer precursor material into the shape of the desired anti-reflective structures 16. Alternatively, the layer of silicone elastomer precursor material can be extruded, coated or otherwise applied onto the micro-replicated major surface of the tooling film and then the exposed back surface of the applied precursor material can be laminated or otherwise brought into contact so as to bond with the surface of the base portion face 20a. Once the formed precursor material is in contact with the surface of the base portion face 20a, the silicone elastomer precursor material is initially cross-linked or cured, followed by subsequent cross-linking to produce the higher cross-link density in at least the surface 18 of the anti-reflective structures 16.

The anti-reflective structures can comprise at least one or a combination of prismatic, pyramidal, conical, hemispherical, parabolic, cylindrical, and columnar structures. The anti-reflective structures comprising prisms can have a prism tip angle of less than about 90 degrees, less than or equal to about 60 degrees, less than or equal to about 30 degrees, or in the range of from about 10 degrees up to about 90 degrees. Such anti-reflective prism structure can also exhibit a trough-to-trough or peak-to-peak pitch in the range of from about 2 microns to about 2 cm. The anti-reflective structures comprising prisms can also have a prism tip angle in the range of from about 15 degrees to about 75 degrees. The anti-reflective structures comprising prisms can also have a pitch in the range of from about 10 microns to about 250 microns.

It can be desirable for the anti-reflective structures to exhibit a refractive index that is less than about 1.55, and preferably a refractive index that is less than about 1.50. When the anti-reflective structures comprise prism structures (e.g., linear prism structures or riblets), it can be desirable for each of the prisms to narrow from their base to a tip having an apex angle that is less than about 90 degrees, and preferably less than or equal to about 60 degrees. It can be desirable for such a prism structure to have a trough to peak height in the range of from about 10 microns to about 250 microns. It can also be desirable for such a prism structure to have a trough to peak height in the range of from about 25 microns to about 100 microns.

It can be desirable for a transparent anti-reflective structured film of the invention to exhibit at least about 85%, 90%, 91%, 92%, 93%, 94%, 95%, 96%, 97%, 98% or 99% light transmission, after the structured surface is exposed to the dirt pick-up test, the falling sand test, or a combination of both tests. These tests are described below. It can also be desirable for a transparent anti-reflective structured film of the invention to exhibit a change in light transmission of less than 8%, 7%, 6%, 5%, 4%, 3%, 2% or 1%, after the structured surface is exposed to the dirt pick-up test, the falling sand test, or a combination of both tests.

A transparent anti-reflective structured film of the invention may also comprise inorganic particles, and preferably nanoparticles in the silicone elastomeric material of the anti-reflective structures. These particles may comprise any suitable inorganic material (e.g., silica, zirconia, titania, etc., or any combination thereof). Such particles may have a size in the range of up to and including about 2.0 microns. Silica particles can be up to the micron size, but it is preferable for particles made of other materials to be used in the nanometer sizes (i.e., in the range of from about 5 nm up to and including about 50 nm). Such particles, especially nanoparticles, may also be loaded into the silicone elastomeric material in the range of from 0 wt. % up to and including about 60 wt. %.

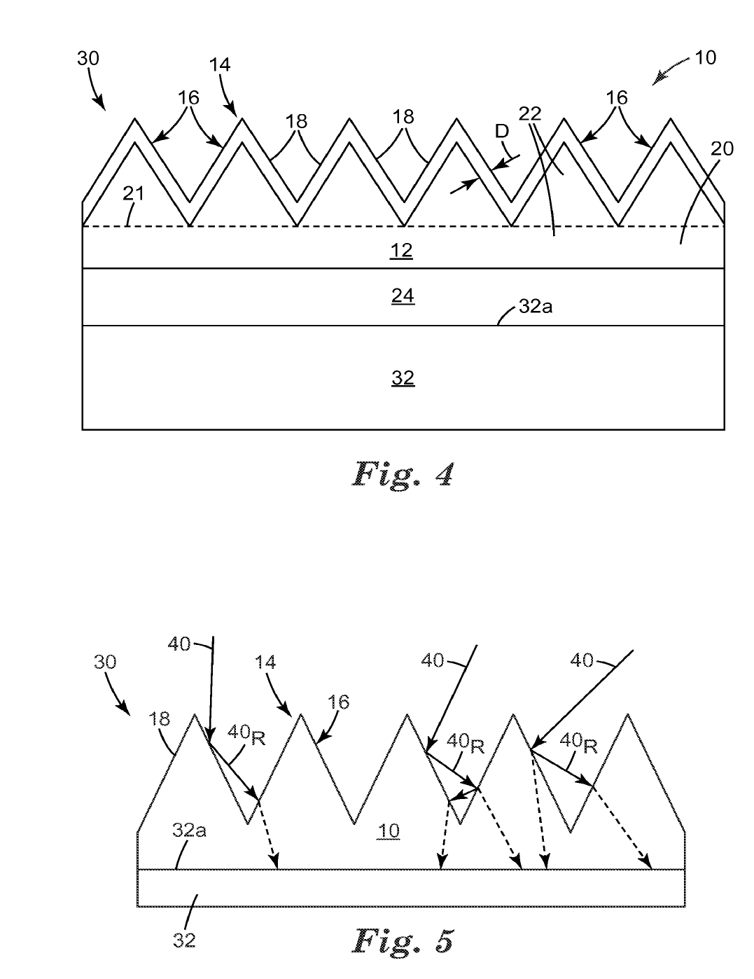

Referring to FIG. 4, any embodiment of a transparent anti-reflective structured film 10 of the invention can be used in a light energy absorbing device 30 such as, for example, a light source thermal energy absorbing device (e.g., a solar hot water system), a photovoltaic device or any other light energy absorbing device. Such a device 30 also comprises a light absorber 32 (e.g., a photovoltaic cell) having a light energy receiving face 32a, with the transparent anti-reflective structured film 10 being disposed relative to the light absorber 32 so as to be between a source of light energy (e.g., the sun) and the light energy receiving face 32a. In this way, light energy from the source passes through the structured film 10 before being absorbed by the light absorber 32. The film 10 can be bonded, adhered, mechanically fastened or otherwise disposed in direct contact with the light energy receiving face 32a. Alternatively, if desired, one or more of a transparent support backing 24 or other intermediate layers can be disposed between the film 10 and the light absorber 32.

Light energy absorbing devices (e.g., solar energy conversion devices) are used in a wide array of applications, both earth-bound applications and space-based applications. In some embodiments, the solar energy conversion device may be attached to a vehicle, such as an automobile, a plane, a train or a boat. Many of these environments are very hostile to organic polymeric materials.

Referring to FIG. 5, by using a transparent anti-reflective structured film 10 of the invention with a light absorber 32 of a light energy absorbing device 30, incident light (represented by arrows 40) striking the surfaces 18 of the anti-reflective structures 16 are likely to be reflected multiple times (represented by arrows 40_{R}). Such multiple reflections of the light 40 increases the probability of light 40 being refracted into the light absorber 32, as well as of increasing the incident light acceptance angles. In this way, the use of such transparent anti-reflective structures can increase the efficiency and energy output of the device 30.

The structured face of the structured film substrate can comprise a series of anti-reflective structures. The structured film substrate may be made with one or multiple materials and/or have a multilayer construction. Alternatively or in addition, the structured film may be a multilayer construction. For example, the film could comprise a structured face made with one material formulation and a separate adhesive-backed base portion made with each of the base and adhesive comprising different material formulations. Additionally, the adhesive could be in the form of one or multiple layers.

Generally, the anti-reflective structures of the structured film substrate are designed such that a substantial portion of reflected light intersects the surface of another anti-reflective structure. In some embodiments, the series of anti-reflective structures comprises a series of essentially parallel peaks separated by a series of essentially parallel valleys. In cross-section, the structured film substrate may assume a variety of wave forms. For example, the cross section of the structured film substrate may assume (1) a symmetric saw tooth pattern in which each of the anti-reflective structure peaks is identical as are each of the corresponding valleys; (2) a series of parallel anti-reflective structure peaks that are of different heights, separated by a series of corresponding parallel valleys; or (3) a saw tooth pattern of alternating, parallel, asymmetric anti-reflective structure peaks separated by a series of parallel, asymmetric valleys. In some embodiments, the anti-reflective structure peaks and corresponding valleys are continuous and in other embodiments a discontinuous pattern of peaks and valleys is also contemplated. Thus, for example, the anti-reflective structure peaks and corresponding valleys may terminate for a portion of the light energy absorbing or conversion device. The valleys may either narrow or widen as the anti-reflective structure peak or valley progresses from one end of the device to the other. Still further, the height and/or width of a given anti-reflective structure peak or corresponding valley may change as the peak or valley progresses from one end of the device to the other. In other embodiments, the series of anti-reflective structures are non-uniform structures. For example, the anti-reflective structures can differ in height, base width, pitch, apex angle, and/or any other structural aspect. In some embodiments, it is desirable for the slope of the anti-reflective structures from the plane of the structured face to average less than 30 degrees from normal. In other embodiments, the anti-reflective structures are substantially symmetrical in one dimension around a perpendicular to the structured face.

When the light absorbing device is a photovoltaic device, the light absorber is a photovoltaic cell for converting solar or other light energy into electrical energy. The anti-reflective structured film reduces surface reflections so as to improve the electrical power output of the photovoltaic cell (i.e., the efficiency in converting light energy into electrical energy). By using a transparent anti-reflective structured film of the invention in this manner, efficiencies in converting light energy to electrical energy may be improved by at least about 3% and possibly in the range of from about 5% up to and including about 10%. Because the transparent anti-reflective structures are in the form of a film, the photovoltaic cell can be sufficiently flexible and pliant so as to be wound into a roll or folded without being damaged.

A light energy absorbing device of the invention can be made by mechanically attaching, adhesively bonding or otherwise securing the anti-reflective structured film to the light absorber so that light can pass through the anti-reflective structured film to the light receiving face of the light absorber (e.g., photovoltaic cell). The light absorber can be, for example, a solar hot water heater or other light generated thermal energy absorbing device, a photovoltaic cell for converting solar or other light energy into electrical energy or a combination thereof.

A transparent anti-reflective structured film according to the present invention can be made by providing a transparent structured film substrate as described above and then treating the structured surface such that the structured surface has a higher silicone elastomer cross-link density than the remainder of the structured film substrate. The structured surface of the structured film substrate can be treated, for example, by being exposed to a treatment (e.g., an e-beam radiation curing treatment) that causes further cross-linking of the cross-linked silicone elastomeric material. Depending on the settings (e.g., intensity, voltage, and/or duration) of the treatment (e.g., conventional e-beam radiation curing techniques) used to further cross-link the already cross-linked silicone elastomeric material, there may be a remaining portion of the structured film substrate that does not exhibit the higher silicone elastomer cross-link density. Low voltage (less than 150 kV) e-beam radiation will create higher cross-link density near the surface of the cross-linked silicone. As seen, for example, in FIG. 2, the treatment settings may also be chosen so that the anti-reflective structures have a silicone elastomer cross-link density about as high as that of the structured surface (i.e., the entire anti-reflective structure is treated so as to exhibit about the same silicone elastomer cross-link density as that of its structured surface). Alternatively, the treatment settings may be chosen so that a core portion of each of the anti-reflective structures does not have a silicone elastomer cross-link density about as high as that of the structured surface (see FIGS. 1, 3 and 4).

The transparent structured film substrate can be made by providing a silicone elastomer precursor material that is curable so as to form the cross-linked silicone elastomeric material. This silicone elastomer precursor material is formed into the shape of the structured film substrate using any suitable forming technique. For example, appropriately sized-grooves can be formed in a substrate and then the substrate used as a mold surface on which the silicone elastomer precursor material is coated so as to cast the major structured face with anti-reflective structures of the structured film substrate. Such a mold substrate can be made, for example, in accordance with the techniques and equipment disclosed in U.S. Patent Publication No. US 2006/0234605, which is incorporated herein by reference in its entirety. While in this shape, the silicone elastomer precursor material is cured so as to form the structured film substrate. Alternatively, the tool disclosed in U.S. Patent Publication No. US 2006/0234605 can be used to cast the appropriately sized-grooves in a polymeric mold substrate (e.g., in the form of a film) that is then used as the mold surface.

Depending on the silicone elastomer precursor material used, the curing process can involve subjecting the precursor material to a cross-linking treatment (e.g., a thermal and/or radiation treatment). When the precursor material is a two-part self curing silicone elastomeric material, the curing process can involve maintaining the precursor material in contact with the mold surface for a long enough period, after the two parts are mixed, to allow cross-linking to occur. Depending on the settings (e.g., intensity and/or duration) of the treatment (e.g., conventional e-beam radiation curing techniques) used to further cross-link the already cross-linked silicone elastomeric material, there may be a remaining portion of the anti-reflective structures, or at least of the structured film substrate that does not exhibit the higher silicone elastomer cross-link density. Alternatively, each anti-reflective structure may be entirely cross-linked to about the higher silicone elastomer cross-link density. To save on energy costs, it can be desirable to minimize the depth and degree to which the structured surface is further cross-linked to a higher silicone elastomer cross-link density.

In some embodiments, the structured film substrate has a variable crosslink density throughout the thickness of the film substrate. For example, there may be a crosslink density gradient across the thickness of the structured film substrate, with the crosslink density being the highest at the structured surface of the structured film substrate and at its lowest at the surface opposite the structured surface. The crosslink density may be increased at the surface of the structured film substrate using electron beam irradiation at relatively low voltages such as in the range of from about 100 kV to about 150 kV.

The following Examples have been selected merely to further illustrate features, advantages, and other details of the invention. It is to be expressly understood, however, that while the Examples serve this purpose, the particular ingredients and amounts used as well as other conditions and details are not to be construed in a manner that would unduly limit the scope of this invention.

### EXAMPLES

### Example 1

RTV615 Part A and RTV615 Part B Available from Momentive Performance Materials of Waterford, N.Y., were mixed at a 10:1 ratio and coated 100 microns thick onto each of four quartz glass slides. The silicone coated quartz glass slides were subsequently heated to 85° C. for 30 minutes in a convection oven to cross-link/cure the thermally curable silicone precursor material. These glass slides coated with cross-linked silicone were then exposed to the e-beam radiation treatments shown in Table 1. The storage modulus of the resulting e-beamed cross-linked silicone coatings were then determined using nano-indentation. Storage modulus changes in these e-beamed silicone coatings are shown in Table 1. An increase in the storage modulus of a sample indicates that the cross-link density of the coating has increased.

TABLE 1

| e-beamed RTV615 silicone | | | Nano-indenter |
|---|---|---|---|
| | e-beam conditions | | Storage Modulus |
| Sample | Voltage (KV) | Power (Mrad) | MegaPascals |
| 1 | 0 | 0 | 12.3 |
| 2 | 120 | 20 | 25.4 |
| 3 | 120 | 40 | 25.8 |
| 4 | 120 | 60 | 29.3 |

Any increase in storage modulus (i.e., cross-link density) of the silicone elastomer surface is desirable. Preferred results have been obtained when the silicone elastomer surface exhibits a storage modulus of at least about 20 MPa, about 25 MPa, about 30 MPa, or higher.

### Example 2

High molecular weight PDMS (PDMS-S51 from Gelest) was coated 100 microns thick onto each of two quartz glass slides. Both silicone coated quartz glass slides (Samples 1 and 2) were exposed to an e-beam treatment to cross-link/cure the curable silicone PDMS precursor material. One of these coated glass slides (Sample 2) was then exposed to an additional e-beam radiation treatment of 140 kV and 60 Mrad.

Samples 1 and 2, along with two uncoated plain quartz glass slides, were subjected to the dirt pick-up test described below, with the initial light transmission (Ti) before being tested, the final light transmission (Tf) after being tested, and the difference between the initial and final light transmissions (Td) being tabulated for each in the below Table 2. The tabulated data shows a significant increase in light transmission for the additionally treated Sample 2 (i.e., that has been additionally cross-linked) compared to the untreated Sample 1 (i.e., that has not been additionally cross-linked). This difference in light transmission is caused by the additionally treated silicone elastomer surface (Sample 2) picking up and holding onto less dirt than the Sample 1. While the tabulated data shows that the light transparency of the plain glass slides was the least affected by the dirt pick-up test, sample 2 had comparable results.

TABLE 2
(Dirt Pick-up Test Results)

| Sample | Tᵢ | T_{f} | T_{d} |
|---|---|---|---|
| 1 | 96.5 | 92.4 | −4.1 |
| 2 | 95.4 | 94.1 | −1.3 |
| Glass Slide 1 | 94.4 | 94.2 | −0.2 |
| Glass Slide 2 | 94.4 | 94.3 | −0.1 |

### Example 3

High molecular weight PDMS (PDMS-S51 from Gelest) was coated 100 microns thick onto each of two quartz glass slides. Both silicone coated quartz glass slides (Samples 1 and 2) were exposed to an e-beam treatment to cross-link/cure the curable silicone PDMS precursor material. One of these coated glass slides (Sample 2) was then exposed to an additional e-beam radiation treatment of 140 kV and 60 Mrad.

Samples 1 and 2, along with one uncoated plain quartz glass slide, were subjected to the falling sand test described below, with the initial light transmission (Ti) before being tested, the final light transmission (TO after being tested, and the difference between the initial and final light transmissions (Td) being tabulated for each in the below Table 3. The tabulated data shows a significant increase in light transmission for the additionally treated Sample 2 (i.e., that has been additionally cross-linked) compared to the untreated Sample 1 (i.e., that has not been additionally cross-linked). This data indicates that additional cross-linking of the cured silicone elastomer material can increase its resistance to surface abrasion. This difference in light transmission is caused by the additionally treated silicone elastomer surface (Sample 2) being less affected by the abrasive sand than the surface of Sample 1. While the tabulated data shows that the light transparency of the plain glass slides was the least affected by the falling sand test, sample 2 had almost identical results.

TABLE 3
(Falling Sand Test Results)

| Sample | Tᵢ | T_{f} | T_{d} |
|---|---|---|---|
| 1 | 96.5 | 92.4 | −4.1 |
| 2 | 95.4 | 94.1 | −1.3 |
| Glass Slide | 94.1 | 93 | −1.1 |

### Test Methods

Dirt Pick-Up Test

As used herein, the dirt pick-up test involves tumbling a sample of the transparent anti-reflective structured film inside a 1 gallon Nalgen jar with 100 grams of fine/dusty Arizona dirt. A 1.5″×2.5″ sample is attached to a larger 3″×5″ piece of 10 mil PET. The sample and dirt tumble due to baffles on the inside of the Nalgen jar, which is laid horizontally on motorized rollers. After two minutes of tumbling the sample is blown off with canned air to remove excess dirt so that only dirt that is bound to the surface remains.

Falling Sand Test

As used herein, the falling sand test involves dropping 1000 g of sand through a 1″ diameter pipe onto the structured surface of the anti-reflective structures.

### Exemplary Embodiments of the Present Invention

### Anti-Reflective Film Embodiment 1

A transparent anti-reflective structured film, sheet, web or the like comprising:

a structured film substrate comprising a major structured face having anti-reflective structures, the structured face being anti-reflective to light, at least the anti-reflective structures comprising a cross-linked silicone elastomeric material, each anti-reflective structure having a structured surface, and the structured surface having a silicone elastomer cross-link density that is higher than a remainder of the anti-reflective structured film.

### Film Embodiment 2

The film according to film embodiment 1, wherein a core portion of each of the anti-reflective structures has a lower silicone elastomer cross-link density than that of the structured surface.

### Film Embodiment 3

The film according to film embodiment 1 or 2, wherein the structured surface has a storage modulus of at least about 20 MPa, and the remainder of the structured film substrate has a lower storage modulus.

### Film Embodiment 4

The film according to any one of film embodiments 1 to 3, wherein the structured surface has a storage modulus of at least about 20 MPa, and the remainder of each anti-reflective structure has a lower storage modulus.

### Film Embodiment 5

The film according to film embodiment 1, wherein the structured film substrate further comprises a base portion from which the anti-reflective structures extend, all of the silicone elastomeric material of each of the anti-reflective structures has a silicone elastomer cross-link density about as high as that of the structured surface, and the base portion has a lower silicone elastomer cross-link density than that of each of the anti-reflective structures.

### Film Embodiment 6

The film according to any one of film embodiments 1 to 5, wherein the anti-reflective structures comprise at least one or a combination of prismatic, pyramidal, conical, parabolic, hemispherical, cylindrical, and columnar structures.

### Film Embodiment 7

The film according to any one of film embodiments 1 to 6, wherein the anti-reflective structures comprise prisms having a prism tip angle of less than about 90 degrees, less than or equal to about 60 degrees, or in the range of from about 10 degrees up to about 90 degrees and a pitch in the range of from about 2 microns to about 2 cm.

### Film Embodiment 8

The film according to any one of film embodiments 1 to 7, wherein the anti-reflective structures comprise prisms having a prism tip angle in the range of from about 15 degrees to about 75 degrees and a pitch in the range of from about 10 microns to about 250 microns.

### Film Embodiment 9

The film according to any one of film embodiments 1 to 8, wherein the anti-reflective structures comprise prisms having a trough to peak height in the range of from about 10 microns to about 250 microns.

### Film Embodiment 10

The film according to any one of film embodiments 1 to 9, wherein the film exhibits at least about 85%, 90%, 91%, 92%, 93%, 94%, 95%, 96%, 97%, 98% or 99% light transmission, after the structured surface is exposed to the dirt pick-up test.

### Film Embodiment 11

The film according to any one of film embodiments 1 to 9, wherein the film exhibits a change in light transmission of less than 8%, 7%, 6%, 5%, 4%, 3%, 2% or 1%, after the structured surface is exposed to the dirt pick-up test.

### Film Embodiment 12

The film according to any one of film embodiments 1 to 11, wherein the film exhibits at least about 85%, 90%, 91%, 92%, 93%, 94%, 95%, 96%, 97%, 98% or 99% light transmission, after the structured surface is exposed to the falling sand test.

### Film Embodiment 13

The film according to any one of film embodiments 1 to 11, wherein the film exhibits a change in light transmission of less than 8%, 7%, 6%, 5%, 4%, 3%, 2% or 1%, after the structured surface is exposed to the falling sand test.

### Film Embodiment 14

The film according to any one of film embodiments 1 to 13, further comprising inorganic nanoparticles (e.g., of silica, zirconia, titania, etc.) in the silicone elastomeric material of the anti-reflective structures. Such particles may have a size in the range of up to and including about 2.0 microns. Silica particles can be up to the micron size, but it is preferable for particles made of other materials to be used in the nanometer sizes (i.e., in the range of from about 5 nm up to and including about 50 nm). Such particles, especially nanoparticles, may also be loaded into the silicone elastomeric material in the range of from 0 wt. % up to and including about 60 wt. %.

### Film Embodiment 15

The film according to any one of film embodiments 1 to 14 in combination with a transparent support backing having a major face, wherein the structured film substrate further comprises a backing face (e.g., a major backing face) bonded to the major face of the support backing so as to form a reinforced anti-reflective structured film. The anti-reflective structures form an exposed surface of the reinforced anti-reflective structured film.

### Film Embodiment 16

The film according to film embodiment 15, wherein the transparent support backing dissipates static electricity.

### Film Embodiment 17

The film according to any one of film embodiments 1 to 16 in combination with a barrier layer, wherein the structured film substrate further comprises a backing face (e.g., a major backing face), and the barrier layer is bonded to the backing face of the structured film substrate.

### Film Embodiment 18

The film according to film embodiment 17, wherein the barrier layer is a moisture barrier.

### Light Energy Absorbing Device Embodiment 1

A light energy absorbing device such as, for example, a light source (e.g., solar) thermal energy absorbing device, a photovoltaic device or any other light energy absorbing device comprising:

a light absorber (e.g., a photovoltaic cell for converting solar or other light energy into electrical energy) having a light energy receiving face; and a transparent anti-reflective structured film, according to any one of film embodiments 1 to 18, disposed relative to the light energy receiving face so as to be between a source of light energy and the light energy receiving face, when the light absorbing device is in use.

### Device Embodiment 2

The device according to device embodiment 1, wherein the light absorbing device is a photovoltaic device comprising a photovoltaic cell, and the anti-reflective structured film reduces surface reflections so as to improve the electrical power output of the photovoltaic cell (i.e., the efficiency in converting light energy into electrical energy) by at least about 3%, and preferably in the range of from about 5-10%.

### Device Embodiment 3

The device according to device embodiment 1 or 2, wherein the light absorbing device is a photovoltaic device comprising a photovoltaic cell that is sufficiently flexible and pliant so as to be folded or at least wound into a roll without being damaged.

### Device Embodiment 4

The device according to device embodiment 1 or 2, wherein the light absorbing device includes a rigid photovoltaic module.

### Device Embodiment 5

The device according to device embodiment 1, wherein the light absorbing device includes a solar thermal panel.

### Device Embodiment 6

The device according to any one of the device embodiments 1 to 5, wherein the transparent anti-reflective structured film of the light absorbing device has a light transmission of greater than 92%, after the structured surface is exposed to the dirt pick-up test.

### Device Embodiment 7

The device according to any one of the device embodiments 1,2 and 4 to 6, wherein the structured film substrate is a coating on a glass substrate.

### Method of Making a Film Embodiment 1

A method of making a transparent anti-reflective structured film according to any one of film embodiments 1 to 18, the method comprising:

providing a transparent structured film substrate comprising a major structured face having anti-reflective structures defining a structured surface, or at least each anti-reflective structure having a structured surface, with the structured face being anti-reflective to light, and the structured film substrate comprising a cross-linked silicone elastomeric material; and

treating the structured surface such that the structured surface has a higher silicone elastomer cross-link density than the remainder of the structured film substrate.

### Method of Making a Film Embodiment 2

A method of making a transparent anti-reflective structured film, the method comprising:

providing a transparent structured film substrate comprising a major structured face having anti-reflective structures defining a structured surface, or at least each anti-reflective structure having a structured surface, with the structured face being anti-reflective to light, and the structured film substrate comprising a cross-linked silicone elastomeric material; and

treating the structured surface such that the structured surface has a higher silicone elastomer cross-link density than the remainder of the structured film substrate.

### Method of Making a Film Embodiment 3

The method according to the method of making a film embodiment 1 or 2, wherein the structured surface is treated such that the anti-reflective structures have a silicone elastomer cross-link density about as high as that of the structured surface.

### Method of Making a Film Embodiment 4

The method according to the method of making a film embodiment 1 or 2, wherein the structured surface is treated such that a core portion of each of the anti-reflective structures does not have a silicone elastomer cross-link density about as high as that of the structured surface.

### Method of Making a Film Embodiment 5

The method according to any one of the method of making a film embodiments 1 to 4, wherein the step of providing a transparent structured film substrate comprises:

providing a silicone elastomer precursor material that is curable so as to form the cross-linked silicone elastomeric material;

forming the silicone elastomer precursor material into the shape of the structured film substrate; and

curing the silicone elastomer precursor material so as to form the structured film substrate.

### Method of Making a Film Embodiment 6

The method according to any one of the method of making a film embodiments 1 to 5, wherein the treating comprises an e-beam radiation curing treatment that causes further cross-linking of the cross-linked silicone elastomeric material.

### Method of Making a Device Embodiment 1

A method of making a light energy absorbing device such as, for example, a light source (e.g., solar) thermal energy absorbing device, a photovoltaic device or any other light energy absorbing device, the method comprising:

providing a transparent anti-reflective structured film according to any one of film embodiments 1 to 18;

providing a light absorber (e.g., a solar hot water heater or other thermal energy absorbing device, a photovoltaic cell for converting solar or other light energy into electrical energy, etc.) having a light receiving face; and

mechanically attaching, adhesively bonding or otherwise securing the anti-reflective structured film in relation to the light absorber so that light can pass through the anti-reflective structured film to the light receiving face of the light absorber.

### Method of Making a Device Embodiment 2

A method of making a light energy absorbing device such as, for example, a light source (e.g., solar) thermal energy absorbing device, a photovoltaic device or any other light energy absorbing device, the method comprising:

making a transparent anti-reflective structured film according to the method of any one of the methods of making a film embodiments 1 to 6;

providing a light absorber (e.g., a solar hot water heater or other thermal energy absorbing device, a photovoltaic cell for converting solar or other light energy into electrical energy) having a light energy receiving face; and

mechanically attaching, adhesively bonding or otherwise securing the anti-reflective structured film in relation to the light absorber so that light can pass through the anti-reflective structured film to the light energy receiving face of the light absorber.

This invention may take on various modifications and alterations without departing from its spirit and scope. Accordingly, this invention is not limited to the above-described but is to be controlled by the limitations set forth in the following claims and any equivalents thereof.

This invention may be suitably practiced in the absence of any element not specifically disclosed herein.

All patents and patent applications cited above, including those in the Background section, are incorporated by reference into this document in total.

1. A transparent anti-reflective structured film comprising:
a structured film substrate comprising a structured face having anti-reflective structures, said structured face being anti-reflective to light, at least said anti-reflective structures comprising a cross-linked silicone elastomeric material, each anti-reflective structure having a structured surface, and said structured surface having a silicone elastomer cross-link density that is higher than a remainder of said anti-reflective structured film.

2. The film according to claim 1, wherein a core portion of each of said anti-reflective structures has a lower silicone elastomer cross-link density than that of the structured surface.

3. The film according to claim 1, wherein said structured film substrate further comprises a base portion from which said anti-reflective structures extend, all of the silicone elastomeric material of each of said anti-reflective structures has a silicone elastomer cross-link density about as high as that of the structured surface, and said base portion has a lower silicone elastomer cross-link density than that of each of said anti-reflective structures.

4. The film according to claim 1, wherein said anti-reflective structures comprise prisms having a prism tip angle in the range of from about 15 degrees to about 75 degrees and a pitch in the range of from about 10 microns to about 250 microns.

5. The film according to claim 1, wherein said film exhibits at least one of (a) a change in light transmission of less than 8%, after said structured surface is exposed to the dirt pick-up test or (b) a change in light transmission of less than 8%, after said structured surface is exposed to the falling sand test.

6. The film according to claim 1 in combination with a transparent support backing having a major face, wherein said transparent support backing dissipates static electricity, and said structured film substrate further comprises a backing face bonded to the major face of said support backing so as to form a reinforced anti-reflective structured film.

7. The film according to claim 1 in combination with a moisture barrier layer, wherein said structured film substrate further comprises a backing face, and said moisture barrier layer is bonded to the backing face of said structured film substrate.

8. A light energy absorbing device comprising:
a light absorber having a light energy receiving face; and
a transparent anti-reflective structured film, according to claim 1, disposed so as to be between a source of light energy and said light energy receiving face, while light energy from the source is being absorbed by said light absorber.

9. A method of making a transparent anti-reflective structured film, said method comprising:
providing a structured film substrate comprising a structured face having anti-reflective structures defining a structured surface, with the structured face being anti-reflective to light, and the structured film substrate comprising a cross-linked silicone elastomeric material; and
treating the structured surface such that the structured surface has a higher silicone elastomer cross-link density than the remainder of the structured film substrate.

10. A method of making a light energy absorbing device, said method comprising:
providing a transparent anti-reflective structured film according to claim 1;
providing a light absorber having a light receiving face; and
securing the anti-reflective structured film in relation to the light absorber so that light can pass through the anti-reflective structured film to the light receiving face of the light absorber.

11. The film according to claim 1, wherein the film exhibits at least about 85% light transmission, after the structured surface is exposed to the dirt pick-up test.

12. The film according to claim 1, wherein the film exhibits a change in light transmission of less than 8% after the structured surface is exposed to the dirt pick-up test.
